(19) United States
(12) Patent Application Publication
(10) Pub. No.: US 2015/0335398 A1
(43) Pub. Date: Nov. 26, 2015

(54) ORTHODONTIC APPLIANCE AND METHOD

(71) Applicant: Mark Rosenthall, Yorktown, IN (US)

(72) Inventor: Mark Rosenthall, Yorktown, IN (US)

(21) Appl. No.: 14/719,403

(22) Filed: May 22, 2015

Related U.S. Application Data
(60) Provisional application No. 62/002,247, filed on May 23, 2014.

(51) Int. Cl. A61C 7/08; A61C 7/30

(52) U.S. Cl. CPC A61C 7/08; A61C 7/30

(57) ABSTRACT

An orthodontic retainer device for maintaining the position of teeth is disclosed. It includes a first bracket that is attachable to a first tooth and a second bracket that is attachable to a second tooth. The retainer device also includes a bar member that has a first bracket connection point that may be attached to the first bracket and a second bracket connection point that may be attached to the second bracket. The second bracket connection point may be removed from the second bracket, and the bar member may hinge around the first bracket connection point.

### CROSS-REFERENCE TO RELATED APPLICATIONS

This application claims the benefit of U.S. Provisional Application No. 62/002,247 filed on May 23, 2014, which is hereby incorporated by reference in its entirety.

### BACKGROUND

The present invention relates to orthodontic retainers and methods for moving orthodontic retainers.

After the position of a person's teeth have been modified using an orthodontic device, such as braces, there is a tendency for the teeth to return to their initial position. Orthodontic retainers are often used to keep teeth in the position to which they had been moved by the prior orthodontic procedure.

Retainers may be removable, but removable retainers are often noticeable and depend on the patient to remember to replace the retainer after it has been removed to keep his or her teeth from shifting. Bonded retainers may be less visible than a removable retainer and require little effort from the patient because they are permanently fixed to the teeth. However, bonded retainers may cause dental hygiene problems because they provide areas where plaque may build up and make it difficult to brush and floss the teeth on which the retainer is bonded. It would be desirable to provide a bonded retainer that is easily moved or removable to allow access to clean the teeth on which the retainer is bonded.

Thus, there is a need for improvement in this field.

### SUMMARY

The claims, and only the claims, recite the invention. In summary, it may include an orthodontic retainer device including a first bracket attachable to a first tooth, a second bracket attachable to a second tooth and a bar member. The bar member includes a first bracket connection member attachable to the first bracket and a second bracket connection member attachable to the second bracket. The second bracket connection member may be detached from the second bracket without damaging the bracket. When the second bracket connection member is detached from the second bracket, the bar member may hinge around the first bracket connection member.

In some embodiments, the second bracket includes a flap portion and a base portion that connects to the second tooth. A bracket opening is formed between the flap portion and the base portion. A resilient member is attached to the side of the base portion that is not attachable to the second tooth, so the resilient member extends into the bracket opening. The second bracket connection member is able to fit within the bracket opening. The second bracket connection member may be removed from the bracket opening by applying force to the resilient member and then pulling the second bracket connection member out of the bracket opening.

Further forms, objects, features, aspects, benefits, advantages, and embodiments of the present invention will become apparent from a detailed description and drawings provided herewith.

### BRIEF DESCRIPTION OF THE DRAWINGS

FIG. 1 is a front view of an orthodontic retainer device.

FIG. 2 is a front view of the orthodontic retainer device of FIG. 1 attached to brackets that are attached to teeth.

FIG. 3 is a top view of the orthodontic retainer device of FIG. 1 in a hinged position.

FIG. 4 is a side view of a bracket with a resilient member for the orthodontic retainer device of FIG. 1.

FIG. 5 is a side view of a bracket made from a resilient material for the orthodontic retainer device of FIG. 1.

FIG. 6 is a side view of a bracket with a hinge and lock where the hinge is closed for the orthodontic retainer of FIG. 1.

FIG. 7 is a side view of a bracket with a hinge and lock where the hinge is open for the orthodontic retainer of FIG. 1.

FIG. 8 is a front view of an adjustable length bar member for an orthodontic retainer device.

FIG. 9 is a flowchart of a method of moving an orthodontic retainer.

### DESCRIPTION OF THE SELECTED EMBODIMENTS

For the purpose of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates. One embodiment of the invention is shown in great detail, although it will be apparent to those skilled in the relevant art that some features that are not relevant to the present invention may not be shown for the sake of clarity.

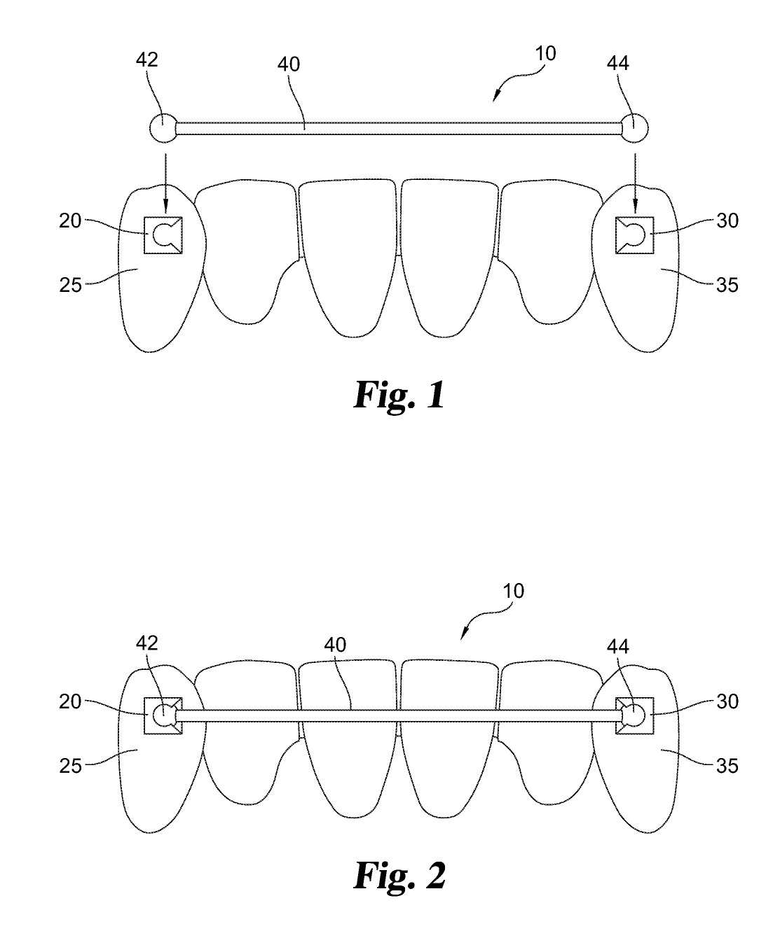

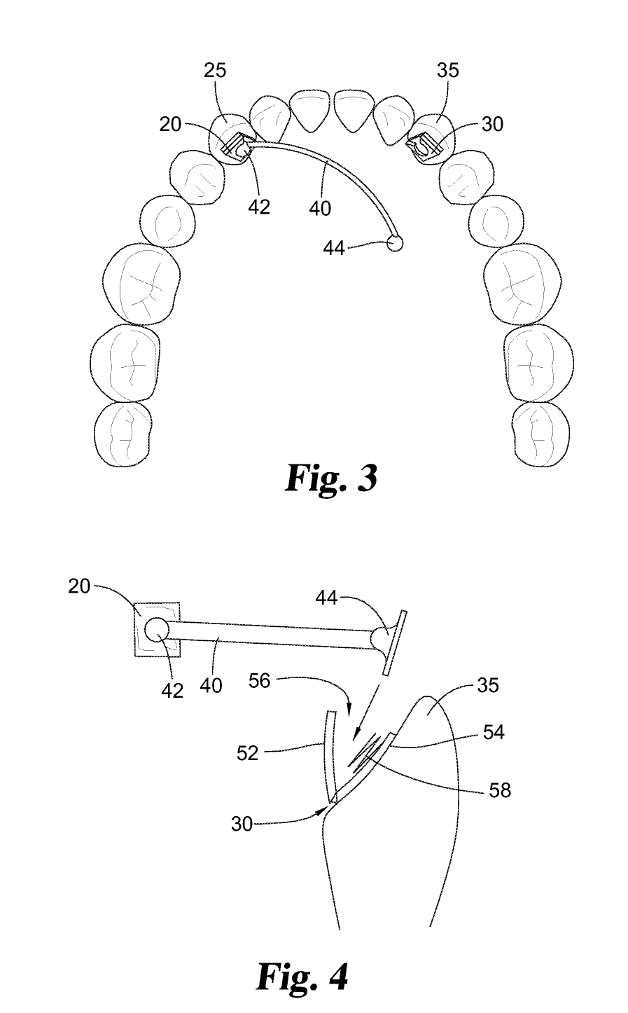

With reference to the drawing Figures, for example FIGS. 1-8, an orthodontic retainer device 10 is shown. Orthodontic retainer device 10 includes a first bracket 20 attachable to a first tooth 25 and a second bracket 30 attachable to a second tooth 35 (see FIG. 1). Orthodontic retainer device 10 also includes a bar member 40 including a first bracket connection member 42 attachable to the first bracket 20 and a second bracket connection member 44 attachable to the second bracket 30 (see FIG. 2). Second bracket connection member 44 may be detached from the second bracket 30 without damaging bracket 30. As seen in FIG. 3, when the second bracket connection member 44 is detached from the second bracket 30, the bar member 40 may hinge around the first bracket connection member 42.

One feature that is optional, but not required may be that the bar member 40 is not movable laterally with respect to the first and second brackets 20, 30 when the first and second bracket connection members 42, 44 are attached to their respective first and second brackets 20, 30.

One feature that is optional, but not be required is that bar member 40 may be hinged around either the first bracket connection member 42 or the second bracket connection member 44. When first bracket connection member 42 is detached from first bracket 20, bar member 40 may hinge around second bracket connection member 44, or when second bracket connection member 44 is detached from second bracket 30, bar member 40 may hinge around first bracket connection member 42.

One feature that is optional, but not required may be that the second bracket 30 includes a flap portion 52 and a base portion 54. As shown in FIG. 4, one side of the base portion 54 is configured to be connected to tooth 35. A bracket opening 56 is formed between the flap portion 52 and the base portion 54. A resilient member 58 is attached to the side of the base portion 54 that is not attached to tooth 35 so the resilient member 58 extends into the bracket opening 56. The second bracket connection member 44 is configured to fit within the bracket opening 56. The second bracket connection member 44 is configured to be removable from the bracket opening 56 by applying a compression force to the resilient member 58 when the second bracket connection member 44 is within the bracket opening 56 and then pulling the second bracket connection member 44 out of bracket opening 56.

In some alternative embodiments, both the first bracket 20 and the second bracket 30 may include the flap portion 52 and base portion 54 and a resilient member 58 situated in bracket opening 56 as described above. In these embodiments, bar member 40 is inserted from above so first bracket connection member 42 is inserted into the bracket opening 56 of first bracket 20 and second bracket connection member 44 is inserted into the bracket opening 56 of second bracket 30. In this embodiment, bar member 40 may or may not be able to hinge about one of the bracket connection members 42, 44.

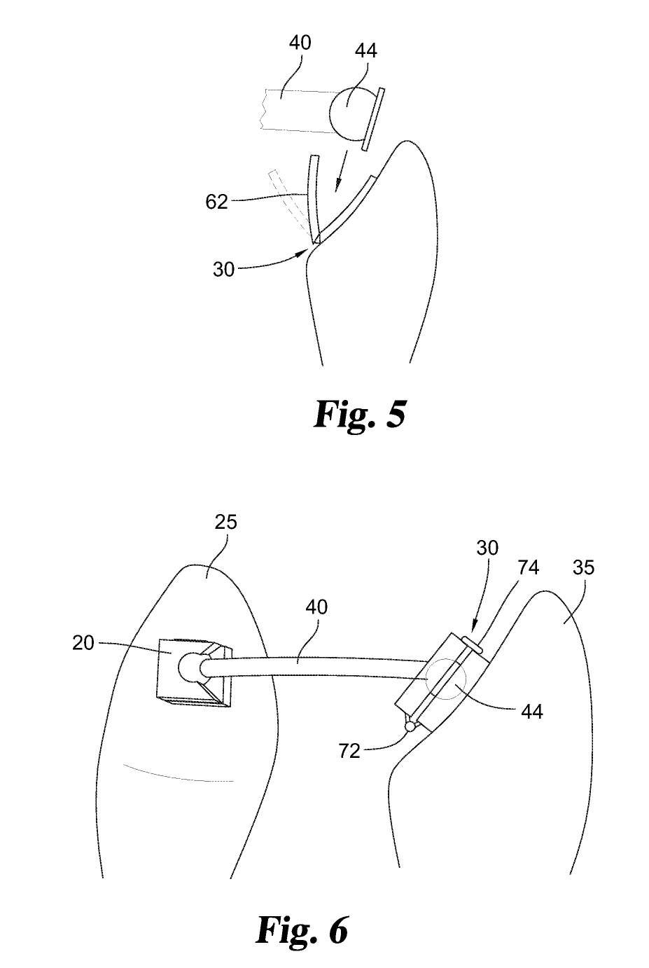

One feature that is optional, but not required may be that the second bracket 30 is made from a resilient material that allows a portion 62 of the second bracket 30 to be bent to receive the second bracket connection member 44 (see FIG. 5). Optionally, a hinge may be added at the bottom of second bracket 30 to allow portion 62 to easily open and close to receive second bracket connection member 44.

In some alternative embodiments, both the first bracket 20 and the second bracket 30 may be made from a resilient material that allows a portion 62 of first bracket 20 and a portion of second bracket 30 to be bent to receive bar member 40. In these embodiments, bar member 40 is inserted from above so first bracket connection member 42 is inserted into the first bracket 20 and second bracket connection member 44 is inserted into second bracket 30. In this embodiment, bar member 40 may or may not be able to hinge about one of the bracket connection members 42, 44.

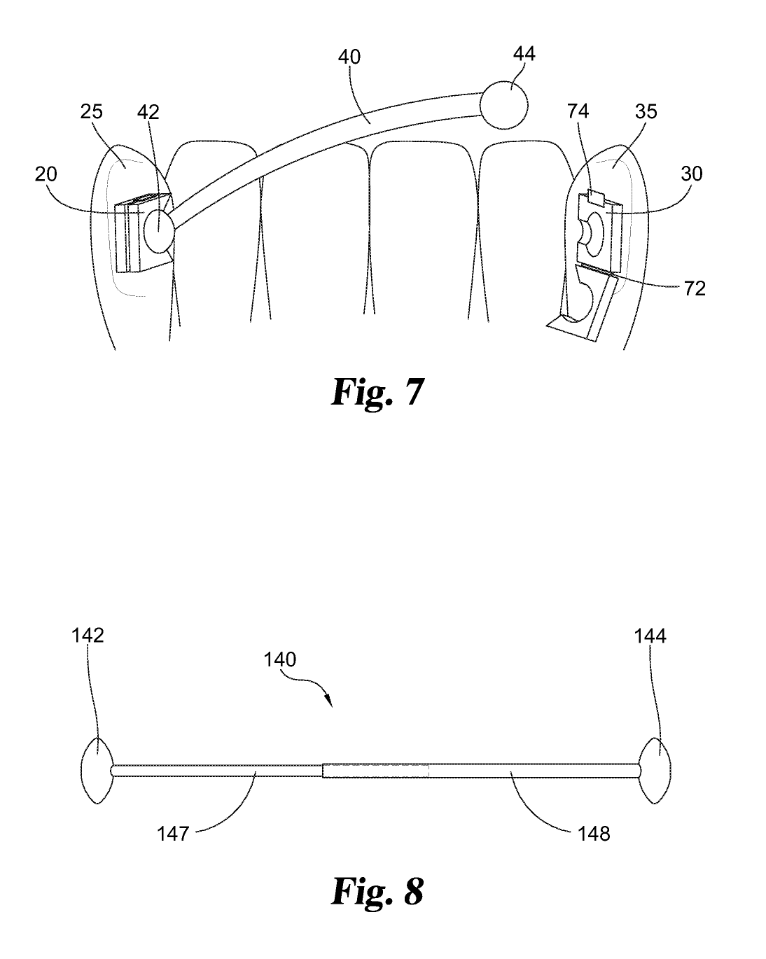

One feature that is optional, but not required may be that the second bracket 30 includes a hinge 72 that is configured to allow said second bracket 30 to open and close to accept or remove said second bracket connection member 44 (see FIG. 6-7). Optionally, the second bracket 30 may also include a lock 74 configured to keep the second bracket 30 from hinging open when the lock 74 is engaged.

One feature that is optional, but not required may be that the bracket connection members 42, 44 are spherical. However, in other embodiments, bracket connection members 42, 44 may be different shapes (see FIG. 8). For example, bracket connection members 42, 44 may be oval, cubical, rectangular, or any other shape that may fit within brackets 20, 30. It is not required that bracket connection members 42, 44 are the same shape. For example, in some embodiments, bracket connection member 42 may be oval shaped while bracket connection member 44 may be spherical.

One feature that is optional, but not required may be that the first bracket 20 is attached to a first tooth 25 by an adhesive, and the second bracket 30 is attached to a second tooth 35 by an adhesive.

One feature that is optional, but not required may be that the bar member is a telescoping bar member 140 (see FIG. 8) that allows a user to change the length of the bar member 140. Telescoping bar member 140 includes a first bracket connection member 142 and a second bracket connection member 144. An inner telescoping portion 147 of bar member 140 is able to slide within an outer telescoping portion 148 of bar member 140. As inner portion 147 is slid within outer portion 148, the length of bar member 140 changes. A user may maintain bar member 140 at a desired length by preventing movement of inner portion 147 within outer portion 148, for example, by crimping outer portion 148 with pliers to disallow inner portion 147 to slide within outer portion 148. Bracket connection members 142, 144 are shown to be oval shaped in FIG. 8, but may be spherical or any other shape in other embodiments.

Another embodiment of orthodontic retainer device 10 includes a first bracket 20 attachable to a first tooth 25 and a second bracket 30 attachable to a second tooth 35. The second bracket 30 includes a flap portion 52 and a base portion 54. One side of the base portion 54 is configured to be connected to tooth 35. A bracket opening 56 is formed between the flap portion 52 and the base portion 54. A resilient member 58 is attached to the side of the base portion 54 that is not attached to tooth 35, so resilient member 58 extends into the bracket opening 56.

A bar member 40 includes a first bracket connection member 42 that is attachable to the first bracket 20 and a second bracket connection member 44 that is attachable to the second bracket 30. The second bracket connection member 44 is configured to fit within the bracket opening 56. The second bracket connection member 44 is configured to be removable from the bracket opening 56 by applying a force, such as a compression force, to the resilient member 58 when the second bracket connection member 44 is within the bracket opening 56 and then pulling the second bracket connection member 44 out of bracket opening 56.

One feature that is optional, but not required is that the first bracket connection member 42 is removable from the first bracket 20.

One feature that is optional, but not required may be that the first bracket 20 includes a hinge that is configured to allow the first bracket 20 to open and close to accept or remove the first bracket connection member 42.

One feature that is optional, but not required may be that the first bracket 20 is made from a resilient material that allows a portion of the first bracket 20 to be bent to receive the first bracket connection member 42.

One feature that is optional, but not required, may be that the first bracket 20 includes a flap portion 52 and a base portion 54. One side of the base portion 54 is configured to be connected to tooth 25. A bracket opening 56 is formed between the flap portion 52 and the base portion 54. A resilient member 58 is attached to the side of the base portion 54 that is not attached to tooth 25 so the resilient member 58 extends into the bracket opening 56. The first bracket connection member 42 is configured to fit within the bracket opening 56. The first bracket connection member 42 is configured to be removable from the bracket opening 56 by applying a compression force to the resilient member 58 when the first bracket connection member 42 is within the bracket opening 56 and then pulling the first bracket connection member 42 out of bracket opening 56.

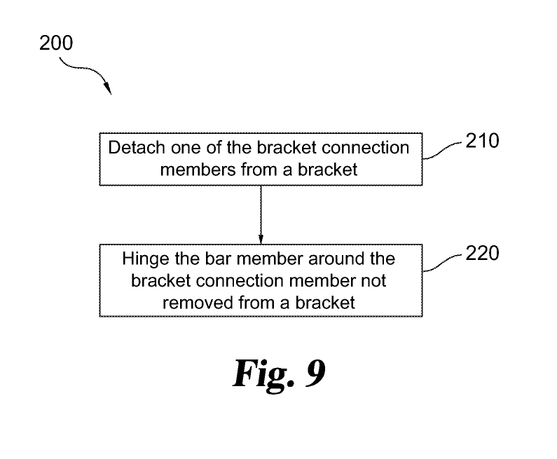

A method of moving an orthodontic retainer 200 is also provided (see flowchart in FIG. 9). The orthodontic retainer device includes a bar member including two bracket connection members. Each of the bracket connection members is connected to a respective bracket. The method may comprise the acts of detaching 210 one of the bracket connection members from its respective bracket. Then the bar member is hinged 220 around the bracket connection point which has not been removed from its respective bracket.

One feature that is optional, but not required is that each of the brackets is attached to a tooth.

One feature that is optional, but not required is that detaching one of the bracket connection members from its respective bracket includes applying force to the bracket.

As used here (claims, specification, and other definitions) the following terms have the following meaning:

Articles and phases such as, “the”, “a”, “an”, “at least one”, and “a first”, “comprising”, “having” and “including” here are not limited to mean only one, but rather are inclusive and open ended to also include, optionally, two or more of such elements and/or other elements. In terms of the meaning of words or terms or phrases herein, literal differences therein are not superfluous and have different meaning, and are not to be synonymous with words or terms or phrases in the same or other claims.

The term “means for” in a claim invokes 35 U.S.C. §112(f), literally encompassing the recited function and corresponding structure and equivalents thereto. Its absence does not, unless there otherwise is insufficient structure recited for that claim element. Nothing herein or elsewhere restricts the doctrine of equivalents available to the patentee.

The term “and/or” is inclusive here, meaning “and” as well as “or”. For example, “P and/or Q” encompasses, P, Q, and P with Q; and, such “P and/or Q” may include other elements as well.

The term “adhesive” means here a substance that is able to stick to another surface or object. Examples of an adhesive include, but are not limited to, bonding cement, resins, or glue.

The term “attachable” means here to be able to affix to, connect or join. An object may be considered attachable if it is affixed to an object permanently or if it is affixed to an object temporarily so that it may be removed.

The term “bar member” means here a long rod or piece of material. A bar member may be rigid or flexible. For example, a bar member could be a wire made of metal or plastic.

The term “base portion” means here a portion of a bracket that is attachable to a tooth and remains fixed to the tooth.

The term “bracket” means here any device that is attachable to the teeth and that is capable of holding a bar member. A bracket may be made of a variety of materials, including, but not limited to metal, ceramic, or plastic. Any method of attachment of a bracket to a tooth is acceptable. For example, a bracket may be attached to a tooth using an adhesive, or a bracket may include a band that wraps around a tooth to form an attachment.

The term “bracket connection member” means here any object that may be held within a bracket. As an example, the bracket connection member could be the portion of a bar member or wire that is held within a bracket. The bracket connection member could be a different shape than the bar member, for example, a spherical bead or any other shaped projection from the bar member that is attachable to a bracket.

The term “bracket opening” means here a gap or a hole in the structure of a bracket that is configured to accept a bar member. As an example, the bracket opening may be formed by the gap between the flap portion and base portion of a bracket.

The term “compression force” means here a force applied to an object that causes that object to press together or occupy less space. A compression force is a force that is applied in the opposite direction of a force that would stretch or strain an object. For example, pressing on an object would apply a compression force.

The term “flap portion” means here a portion of a bracket that is attached on one side and covers an opening. A flap portion does not have to be permanently attached only at one side. It is possible that both sides of a flap portion may be attached or connected to the bracket as long as the connection at one side may be detached.

The term “hinge” means here a joint on which an object or device may turn, swing, or rotate.

The term “hinge around” means here to be able to pivot, rotate, or to hinge about a specified point. The amount of rotation that is allowed may vary. For example, the allowed rotation may encompass a full 360 degrees in any direction, or may be limited to movement in a single direction at less than 360 degrees.

The term “inner telescoping portion” means here the part of a telescoping structure that fits within and slides within another part of the telescoping structure.

The term “lock” means here any mechanism for keeping an object fastened or closed. A lock requires some action to open or unfasten the object. As an example, the action could be, but is not limited to, applying force to the lock, turning, or inserting a key.

The term “movable laterally” means here to be capable of moving to either side of a set reference point.

The term “orthodontic retainer” means here any dental device that is designed to hold teeth in a desired position. In contrast to braces that actively place pressure in teeth to cause movement, a retainer is not designed to adjust the position of teeth.

The term “outer telescoping portion” means here the larger part of a telescoping structure that a smaller part of the telescoping structure may slide within.

The term “resilient material” means here any material that has the ability to return to an original form after the shape of that material has been altered. Examples of a resilient material include, but are not limited to, rubber or a pliable metal.

The term “resilient member” means here an object that has the ability to return to an original form after the shape of the object has been changed, for example, by being bent, compressed, or stretched. A resilient member may be made from any material that exhibits this property. As an example, a resilient member could be, but is not limited to, a spring.

The term “spherical” means here having round, curved shaped where every point on the surface is equidistant from the center. Small variations within acceptable tolerance limits are allowed.

The term “within said bracket opening” means here positioned at least partially or fully within the bracket opening of a bracket.

The term “without damaging said bracket” means here that a bracket connection member may be removed without causing physical harm to the bracket that would impair the bracket's ability to function correctly. Some harm may be caused to the bracket, such as scratches or minor damage, as long as the bracket is still able to receive and hold a bracket connection member.

The invention may include any one or more articles or devices made by any of the claimed methods and/or may by different methods but with a claimed composition.

The language used in the claims and the written description and in the above definitions is to only have its plain and ordinary meaning, except for terms explicitly defined above. Such plain and ordinary meaning is defined here as inclusive of all consistent dictionary definitions from the most recently published (on the filing date of this document) general purpose Webster's dictionaries and Random House dictionaries.

While the invention has been illustrated and described in detail in the drawings and foregoing description, the same is to be considered as illustrative and not restrictive in character, it being understood that only the preferred embodiment has been shown and described and that all changes, equivalents, and modifications that come within the spirit of the inventions defined by following claims are desired to be protected. All publications, patents, and patent applications cited in this specification are herein incorporated by reference as if each individual publication, patent, or patent application were specifically and individually indicated to be incorporated by reference and set forth in its entirety herein.

What is claimed is:

1. An orthodontic retainer device comprising:
a) a first bracket attachable to a first tooth;
b) a second bracket attachable to a second tooth;
c) a bar member including:
i) a first bracket connection member attachable to said first bracket;
ii) a second bracket connection member attachable to said second bracket, wherein said second bracket connection member may be detached from said second bracket without damaging said bracket;
wherein when said second bracket connection member is detached from said second bracket, said bar member may hinge around said first bracket connection member.

2. The orthodontic retainer device of claim 1, wherein said bar member is not movable laterally with respect to said first and second brackets when said first and second bracket connection members are attached to said respective first and second brackets.

3. The orthodontic retainer device of claim 1, wherein when said first bracket connection member is detached from said first bracket, said bar member may hinge around said second bracket connection member.

4. The orthodontic retainer device of claim 1, wherein said second bracket includes:
i) a flap portion;
ii) a base portion connected to said second tooth;
iii) a bracket opening formed between said flap portion and said base portion;
iv) a resilient member attached to the side of said base portion not attachable to said second tooth, so said resilient member extends into said bracket opening;
wherein said second bracket connection member is configured to fit within said bracket opening; and,
wherein said second bracket connection member is configured to be detachable from said bracket opening by applying compression force to said resilient member when said second bracket connection member is within said bracket opening.

5. The orthodontic retainer device of claim 1, wherein said second bracket is made from a resilient material that allows a portion of said second bracket to be bent and receive said second bracket connection member.

6. The orthodontic retainer device of claim 1, wherein said second bracket includes a hinge that is configured to allow said second bracket to open and close to accept or remove said second bracket connection member.

7. The orthodontic retainer device of claim 6, wherein said second bracket includes a lock configured to keep said second bracket from hinging open when engaged.

8. The orthodontic retainer device of claim 1, wherein said bracket connection members are spherical.

9. The orthodontic retainer device of claim 1, wherein said first bracket is attached to a first tooth by an adhesive, and wherein said second bracket is attached to a second tooth by an adhesive.

10. The orthodontic retainer device of claim 1 wherein said bar member comprises an inner telescoping portion and outer telescoping portion, and wherein said inner telescoping portion is configured to slide within said outer telescoping portion to change the length of said bar member.

11. An orthodontic retainer device comprising:
a first bracket attachable to a first tooth;
a second bracket attachable to a second tooth, said second bracket including:
i) a flap portion;
ii) a base portion, wherein one side of said base portion is configured to be connected to a tooth;
iii) a bracket opening formed between said flap portion and said base portion;
iv) a resilient member attached to the side of said base portion not attached to said second tooth, so said resilient member extends into said bracket opening;
a bar member including, a first bracket connection member attachable to said first bracket, a second bracket connection member attachable to said second bracket, and wherein said second bracket connection member is configured to fit within said bracket opening; and,
wherein said second bracket connection member is configured to be detachable from said bracket opening by applying compression force to said resilient member when said second bracket connection member is within said bracket opening.

12. The orthodontic retainer device of claim 11, wherein said bar member is not movable laterally with respect to said first and second brackets when said first and second bracket connection members are attached to said respective first and second brackets.

13. The orthodontic retainer device of claim 12, wherein when said bracket connection member is removed from said second bracket, said bar member may hinge around said first bracket connection member.

14. The orthodontic retainer device of claim 12, wherein when said first bracket connection member is detached from said first bracket, said bar member may hinge around said second bracket connection member.

15. The orthodontic retainer device of claim 11, wherein said first bracket connection member is removable from said first bracket.

16. The orthodontic retainer device of claim 15, wherein said first bracket includes a hinge that is configured to allow said first bracket to open and close to accept or remove said first bracket connection member.

17. The orthodontic retainer device of claim 15, wherein said first bracket is made from a resilient material that allows a portion of said first bracket to be bent and receive said first bracket connection member.

18. The orthodontic retainer device of claim 15, wherein said first bracket includes:
i) a flap portion;
ii) a base portion connected to said first tooth;
iii) a bracket opening formed between said flap portion and said base portion;
iv) a resilient member attached to the side of said base portion not attached to said first tooth, so said resilient member extends into said bracket opening;
wherein said first bracket connection member is configured to fit within said bracket opening; and,
wherein said first bracket connection member is configured to be detachable from said bracket opening by applying compression force to said resilient member when said first bracket connection member is within said bracket opening.

19. The orthodontic retainer device of claim 15, wherein said bracket connection members are spherical.

20. The orthodontic retainer device of claim 15, wherein said first bracket is attached to a first tooth by an adhesive, and wherein said second bracket is attached to a second tooth by an adhesive.

21. The orthodontic retainer device of claim 11 wherein said bar member comprises an inner telescoping portion and outer telescoping portion, and wherein said inner telescoping portion is configured to slide within said outer telescoping portion to change the length of said bar member.

22. A method of moving an orthodontic retainer including a bar member including two bracket connection members wherein each of said bracket connection members is connected to a respective bracket, the method comprising the acts of:
detaching one of said bracket connection members from said respective bracket;
hinging said bar member around said bracket connection point which has not been removed from said respective bracket.

23. The method of claim 22, wherein each of said brackets is attached to a tooth.

24. The method of claim 22, wherein said detaching one of said bracket connection members from said respective bracket includes applying force to said bracket.
